(19) United States
(12) Patent Application Publication
(10) Pub. No.: US 2024/0378868 A1
(43) Pub. Date: Nov. 14, 2024

(54) Systems and Methods for Adaptive Data Labelling to Enhance Machine Learning Precision

(71) Applicant: AvaWatz Company, Dallas, TX (US)

(72) Inventors: Rishabh Iyer, McKinney, TX (US); John McKendry, Ashby, MA (US); Rajini Anachi, Frisco, TX (US)

(73) Assignee: AvaWatz Company, Dallas, TX (US)

(21) Appl. No.: 18/656,988

(22) Filed: May 7, 2024

Related U.S. Application Data
(60) Provisional application No. 63/501,030, filed on May 9, 2023.

(51) Int. Cl. G06V 10/776; G06V 10/774; G06V 10/94

(52) U.S. Cl. CPC G06V 10/776; G06V 10/774; G06V 10/945

(57) ABSTRACT

The disclosed system enhances machine learning precision through adaptive data labeling. It includes components for smart selection of unlabeled data, user labeling, model training, tiered-hardness based selection, consensus-based auto-labeling, automatic evaluation and error analysis, and targeted selection. The system selects a subset of unlabeled data, enables manual labeling, trains a machine learning model, selects data samples based on hardness tiers, automatically labels selected samples, identifies model weaknesses, and selects additional unlabeled data similar to identified weaknesses. The system may also include a data augmentation component to increase the diversity, richness, and quantity of labeled data.

### CROSS-REFERENCE TO RELATED APPLICATION(S)

This application claims the benefit of priority under 35 U.S.C. §§ 120 and 119 (e) of U.S. Provisional Application No. 63/501,030, filed May 9, 2023, entitled “System and Method for Labeling, Evaluation, and Improvement of Training and Testing Data for Machine Learning.”

The contents of each of the above referenced applications are hereby incorporated by reference in its entirety.

### TECHNICAL FIELD

Various aspects of the present disclosure relate generally to systems and methods for for adaptive data labelling and, more particularly, to systems and methods for adaptive data labelling to enhance machine learning precision.

### BACKGROUND

Machine Learning (ML) and Deep Learning (DL) technologies have made remarkable strides in recent years, propelling forward the capabilities in computer vision, natural language processing, and beyond. The surge of deep learning applications across various domains can be largely attributed to sophisticated models and the creation of expansive labeled datasets. Yet, a key hurdle remains: the laborious and costly process of data labeling. For deep models to function effectively, they require vast quantities of high-quality, labeled data, turning the labeling process into a significant bottleneck.

Labeling datasets is both a financial and temporal investment. It is not uncommon for applications to require tens of thousands, if not hundreds of thousands, of labeled examples, necessitating months of work and potentially costing from tens to hundreds of thousands of dollars. The stakes are even higher in specialized fields like medical imaging, where labeling by skilled professionals like radiologists can cost anywhere from $50 to $500 per hour, with each image taking several minutes to annotate correctly.

As we move from creating a basic ML model to improving its performance, we encounter the principle of diminishing returns. It is relatively straightforward to develop a model with 60-70% accuracy; such a “basic model” generally performs well on the most common patterns, or the ‘head’ of the data distribution. However, pushing the model's accuracy to the next tier, to a “good model” say 80-90%, begins to underscore the cost of precision. These gains in accuracy come at a high price, as the model now must learn to interpret more complex and less frequent patterns—the ‘long tail’ of the distribution. Obtaining a “near perfect model” which can achieve a 95%+ accuracy is much harder requiring the model to do almost perfectly on both the frequent (head) data as well as infrequent (tail) data.

The long tail phenomenon represents the variety of infrequent cases and rare patterns that are not well-represented in the initial training data. To enhance a model's performance on these, a significant amount of additional data is needed-data that captures the nuances and intricacies of these fewer common occurrences. Consequently, the effort to go from a decent model that performs well on common patterns to a good model that also handles the rare cases adequately becomes increasingly challenging.

The final leap in model development is the most arduous. Transitioning from a “good model”, which exhibits high accuracy on the ‘head’ and decent on the ‘tail’, to a “near-perfect model” that performs excellently on both, embodies the crux of the diminishing returns dilemma. For example, the CIFAR-10 dataset demonstrates that achieving an accuracy of 90% requires significantly more labeled data than reaching an initial 80%. Each step toward 95% accuracy or beyond demands a disproportionate increase in labeled data for relatively minor gains.

The three phases of model development-starting with a basic model, refining it to a good model, and finally pushing for a near-perfect model-reflect a trajectory of escalating effort with progressively smaller returns. This journey underscores the complex balance between investment in data labeling and incremental performance improvements, especially as the model nears high levels of accuracy. With each phase of refinement, the challenge intensifies, marking the hardest part of model development as moving from a good to a near-perfect model, a task that is as data-intensive as it is critical for achieving state-of-the-art performance.

The present disclosure is directed to overcoming one or more of these above-referenced challenges.

### SUMMARY OF THE DISCLOSURE

According to certain aspects of the disclosure, systems, methods, and computer readable memory are disclosed for adaptive data labelling to enhance machine learning precision.

In some cases, a system for adaptive data labelling to enhance machine learning precision may include: one or more memories configured to store instructions; and one or more processors configured to, when executing the instructions, perform operations for a plurality of components. The plurality of components include: a smart selection component configured to select a subset of unlabeled data; a user labeling component configured to enable a user to manually label the selected subset of unlabeled data; a model training component configured to train a machine learning model using the labeled subset of data; a tiered-hardness based selection component configured to select data samples based on hardness tiers; a consensus-based auto-labeling component configured to automatically label the selected data samples; an automatic evaluation and error analysis component configured to identify weaknesses in the machine learning model; and a targeted selection component configured to select additional unlabeled data samples similar to the identified weaknesses.

In some cases, a computer-implemented method for adaptive data labelling to enhance machine learning precision may include: selecting a subset of unlabeled data; enabling a user to manually label the selected subset of unlabeled data; training a machine learning model using the labeled subset of data; selecting data samples based on hardness tiers; automatically labeling the selected data samples; identifying weaknesses in the machine learning model; and selecting additional unlabeled data samples similar to the identified weaknesses.

In some cases, an adaptive data labeling system may include (i) a smart selection and initial labeling component, (ii) a tiered hardness based selection and consensus based automatic labeling component, and a targeted selection and automatic labeling component.

Additional objects and advantages of the disclosed technology will be set forth in part in the description that follows, and in part will be apparent from the description, or may be learned by practice of the disclosed technology.

It is to be understood that both the foregoing general description and the following detailed description are exemplary and explanatory only and are not restrictive of the disclosed technology, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed technology.

FIG. 1A depicts an example environment for adaptive data labelling to enhance machine learning precision.

FIG. 1B depicts a chart of accuracy versus labeled set size.

FIG. 2 depicts a flowchart of a labeling system.

FIG. 3 shows a block diagram of components of a labeling system.

FIG. 4 depicts the workflow of first Phase of a labeling system.

FIG. 5 depicts a workflow for a diversity selection module.

FIG. 6 depicts a workflow for a synthetic data augmentation module.

FIG. 7 depicts a workflow of a second phase of a labeling system.

FIG. 8 depicts a workflow of a tiered hardness based selection module.

FIG. 9 depicts a workflow of an automatic labeling module.

FIG. 10 depicts a workflow for a third phase of a labeling system.

FIG. 11 depicts a workflow for an evaluation component.

FIG. 12 depicts a workflow for a targeted selection component.

FIG. 13 depicts a workflow of a targeting module in a targeted selection component.

FIG. 14 depicts a system that may execute techniques presented herein.

### DETAILED DESCRIPTION

The present disclosure generally relates to machine learning, and more particularly to a machine learning system that can automatically label and automatically evaluate machine learning models resulting in significant labeling efficiencies. The technology of the present disclosure significantly reduces the cost and time taken to label large datasets-providing for ten times to one hundred times, or more, speedups in the labeling process. In some cases, the present disclosure uses a framework, which can “guide” a user to go from a basic model to a near perfect model with the least amount of labeling effort.

The present disclosure teaches features of a labeling system 12c. In some cases, the labeling system 12c may include at one or more novel components: (i) smart selection: a data selection component that can be configured to select a subset of unlabeled data for initial human labeling, (ii) tiered hardness based selection mechanism: a tiered hardness based automatic labeling component which labels data in an automatic or semi-automatic manner (e.g., with a small amount of human verification), (iii) consensus based auto-labeling: an auto-labeling framework which uses one or more models for auto-labeling, (iv) auto-evaluation and error analysis: an automatic evaluation and error analysis component to figure out classes and slices where the model is struggling in, and (iv) targeted learning: a targeted selection and filtering component to target rare or hard data samples that the model is straggling in and filter out outlier and not useful data.

Additionally, the labeling system 12c may also include one or more machine learning components. For instance, the one or more machine learning components: (i) a data augmentation component that can be configured to augment the labeled data with various data transformations to increase the amount of labeled data, (ii) a user labeling component, wherein a user can label the selected data instances or fix existing labels, and, (iii) model training and refinement component that can be configured to train the models on the user labeled and automatic/system labeled instances.

The methodologies outlined herein can also be executed through a computer-readable medium that encompasses computer-executable instructions. When these instructions are executed by a computing device, they enable the device to execute a sequence of operations for enhancing machine learning models. This sequence may include training an initial model on new, unseen data scenarios to establish a baseline ‘decent’ model. Subsequent processes may involve assessing this model using one or more advanced models with higher computational capacity. The evaluation focuses on determining the initial model's accuracy and based on this assessment, integrating additional data scenarios to refine the advanced models. Thereafter, the initial model may be retrained in conjunction with these enhanced models to improve its accuracy. Through iterative training and evaluation, the process may culminate in the production of a model with high accuracy.

The benefits of the disclosed adaptive data labeling system include:

Efficiency in Labeling: The system's ability to automatically label data and evaluate machine learning models leads to a dramatic reduction in the time and cost associated with labeling large datasets. This efficiency may be achieved through the use of smart selection, tiered hardness based selection, and consensus-based auto-labeling, which together streamline the labeling process.

Guided Model Improvement: The framework may provide guidance to users on how to evolve a basic machine learning model into a near-perfect model with the least amount of labeling effort. This guidance may be particularly valuable for users who may not have extensive experience in machine learning.

Enhanced Precision: By targeting rare or hard data samples that the model struggles with, the system may ensure that the machine learning models are trained on the full spectrum of data, including the ‘long tail’ that often contains the more complex and less frequent patterns. This targeted approach may result in models with higher precision and better performance on a wider range of data scenarios.

Cost, Time, or Compute Savings: The system's components and methodologies can lead to cost, time, or compute savings by reducing the reliance on expensive human labeling and re-training, especially in specialized fields where expert annotation is costly.

Scalability: The system's components are designed to handle large datasets efficiently, making it scalable for applications that require processing vast amounts of data.

Flexibility: The system can be adapted to various domains and applications, from autonomous driving to medical imaging, demonstrating its flexibility and wide applicability.

State-of-the-Art Performance: By addressing the diminishing returns dilemma in model development, the system may aid in achieving state-of-the-art performance in machine learning models, pushing the boundaries of what is possible with current technology.

User Empowerment: The system empowers users by providing tools and components that facilitate the development of high-accuracy machine learning models without requiring deep expertise in the field.

Reduction of Label Noise: The consensus-based auto-labeling component may ensure that labels are accurate by using multiple models to reach a consensus, thereby reducing label noise and improving the quality of the training data.

Iterative Refinement: The system supports iterative training and evaluation, allowing for continuous refinement of machine learning models to improve accuracy over time.

Thus, methods and systems of the present disclosure may be improvements to computer technology and/or machine learning technology.

### Environment

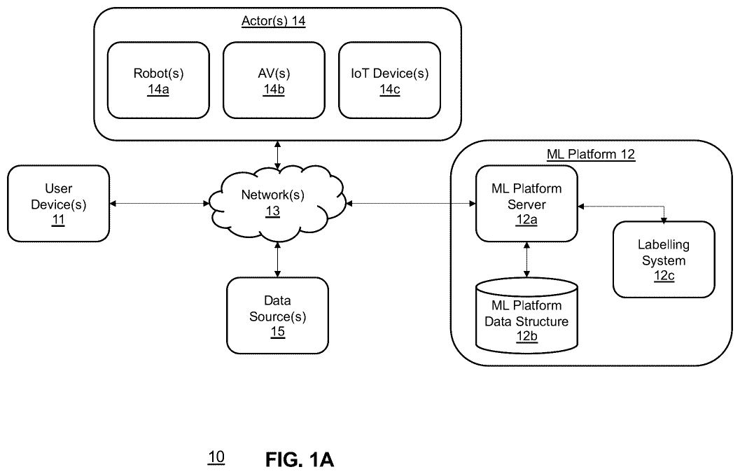

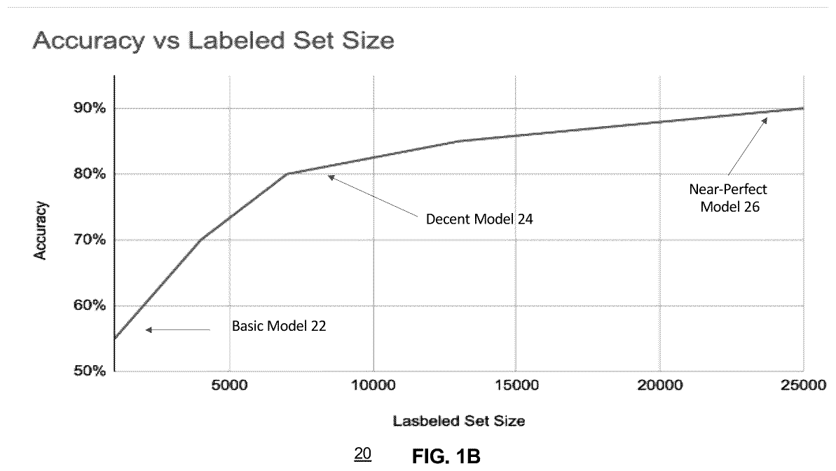

FIG. 1A depicts an example environment 10 for adaptive data labelling to enhance machine learning precision. The environment 10 may include user device(s) 11, network(s) 13, actor(s) 14 (such as robot(s) 14a, autonomous vehicle(s) 14b, and/or IoT device(s) 14c), a ML platform 12 (including, e.g., a ML platform server 12a, a ML platform data structure 12b, and a labeling system 12c), and data source(s) 15.

The user device(s) 11 may (hereinafter “user device 11” for ease of reference) may be a personal computing device, such as a cell phone, a tablet, a laptop, or a desktop computer. In some cases, the user device 11 may be an extended reality (XR) device, such as a virtual reality device, an augmented reality device, a mixed reality device, and the like. In some cases, the user device 11 may be associated with a user (e.g., a customer or engineer of the ML platform 12). The user/engineer may have an account associated with the ML platform 12 that uniquely identifies the user/engineer within the ML platform 12. Additional features of the user device 11 and interactions with other devices are described below.

The network(s) 13 may include one or more local networks, private networks, enterprise networks, public networks (such as the internet), cellular networks, and satellite networks, to connect the various devices in the environment 10. Generally, the various devices of the environment 10 may communicate over network(s) 13 using, e.g., network communication standards that connect endpoints corresponding to the various devices of the environment 10.

The actor(s) 14 (“actor 14” for ease of reference) may be any combination of one or more of: robot(s) 14a, autonomous vehicle(s) 14b, and/or IoT device(s) 14c. In some cases, the robot(s) 14a may include land (e.g., indoor or outdoor), air, or sea autonomous machines. In some cases, the AV(s) 14b may be a car, a truck, a trailer, a cart, a snowmobile, a tank, a bulldozer, a tractor, a van, a bus, a motorcycle, a scooter, or a steamroller. The IoT device(s) 14c may be any internet connected device that performs actions in accordance with software. Generally, the actor(s) 14 may process input (e.g., sensor data such as from data source(s) 15, instructions from other actor(s), instructions from user devices 11, instructions from ML platform 12, and the like) and perform actions. In some cases, the actor(s) 14 may host ML models or receive inputs from other devices (e.g., ML platform 12) based on ML models hosted on those other devices. The ML models may identify aspects of the environment, make decisions about how to navigate or path plan through the environment, and make decisions about how to perform functions (e.g., physical actions or software functions) with respect to the environment (including physical and/or software features of the environment).

The ML platform 12 may generate, update, and/or host ML models for the environment 10. In some cases, the ML platform server 12a may coordinate data and/or instructions between various devices of the environment, such as the user device 11 and an actor 14. The ML platform server 12a may be a computer, a server, a system of servers, and/or a cloud environment (e.g., using virtual machines and the like). The ML platform server 12a may also manage data stored and provided from the ML platform data structure 12b. The ML platform data structure 12b may store and manage relevant data for user device(s) 11, relevant data for actor(s) 14, data from data source(s) 15. The ML platform data structure 12b may include one or combinations of: a structured data store (e.g., a database), an unstructured data store (e.g., a data lake), files, and the like.

The data source(s) 15 may include relevant data feeds to the various user device(s) 11, users/engineers of the user device(s) 11, ML models, actor(s) 14 and the like. For instance, in some cases, the data source(s) 15 may include a map provider, a satellite image provider, weather data provider, and the like.

The labeling system 12c may be a comprehensive framework designed to streamline the process of data labeling for machine learning models. The labeling system 12c may use components such as smart selection for initial data subset identification, tiered-hardness based selection for efficient automatic labeling with varying degrees of human verification, and consensus-based auto-labeling that utilizes multiple models to ensure accuracy. Additionally, the labeling system 12c features an automatic evaluation and error analysis component to pinpoint model weaknesses, and a targeted learning component to focus on rare or challenging data samples. The labeling system 12c may also include machine learning components for data augmentation, user labeling, and model training and refinement. Collectively, these features enable the labeling system 12c to dramatically reduce the time and cost associated with labeling large datasets, guiding users from basic to near-perfect model accuracy with minimized labeling effort.

### Chart Depicting Diminishing Returns

FIG. 1B depicts a chart 20 of accuracy versus labeled set size. The features of FIG. 1B may apply to any of FIGS. 1A, 2, 3, 4, 5, 6, 7, 8, 9, 10, 11, 12, 13, and 14.

The chart 20 may show diminishing returns observed in training machine learning models. The chart 20 may show a model may progress (in accuracy for different labeled set sizes) from a basic model 22 to a decent model 24, and from the decent model 24 to a near-perfect model 26.

### Flowchart of Labeling System

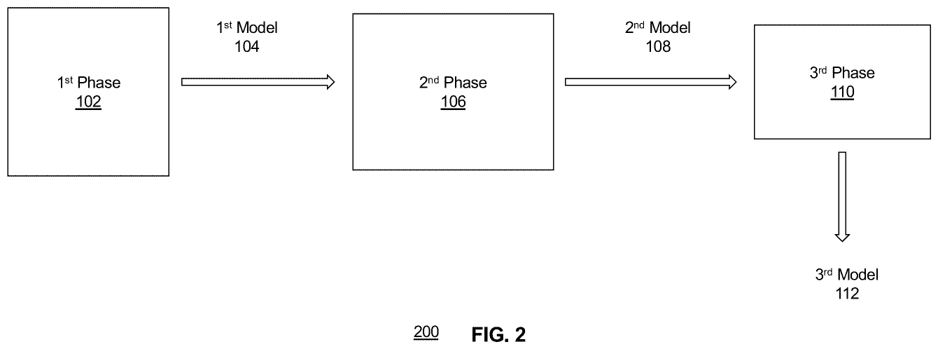

FIG. 2 depicts a flowchart 200 of a labeling system 12c. The features of FIG. 2 may apply to any of FIGS. 1A, 1B, 3, 4, 5, 6, 7, 8, 9, 10, 11, 12, 13, and 14. The flowchart 200 may have three phases—a first phase 102, a second phase 106, and a third phase 110.

In some cases, the first phase 102 may include a process of smart selection and initial labeling to provide a first model 104 (e.g., a basic model). In the first phase 102, the labeling system 12c may determine a representative and diverse subset of unlabeled data, which will then be labeled by a user. The labeling system 12c may select a subset of unlabeled data (e.g., 2-5% of the dataset) to train a model and generate the first model 104. For instance, on a dataset like CIFAR-10, the first model 104 may be a model which achieves a 50% accuracy with 1000 diverse selected samples.

In some cases, the second phase 106 may include a process of tiered hardness and automatic labeling to provide a second model 108 (e.g., a decent model). In the second phase 106, the labeling system 12c may select data samples based on one or more (e.g., a plurality of) hardness tiers. In some cases, the one or more hardness tiers may include three hardness tiers. For instance, the three hardness tiers may include a first hardness tier, a second hardness tier, and a third hardness tier. The first hardness tier may select a first set samples that the model is decently confident about (e.g., above a first confident threshold) and automatically labels the selected first set samples. The second hardness tier may select a second set samples of intermediate hardness for verification (e.g., below the first confident threshold and above a second confidence threshold). The labeling system 12c may request a user to verify the labels automatically assigned to the samples of intermediate hardness. The third hardness tier may select a third set samples (e.g., samples with confidences below the second confidence threshold). In these cases, the labeling system 12c may request human labeling for the third set of samples. In some cases, the first hardness tier may be fully auto-labeled without any human input. In some cases, the second and third hardness tiers may use human inputs (e.g., verification or labels). In some cases, the second hardness tier use much less human input compared to the third hardness tier. For instance, based on prior studies, it has been observed that labeling from scratch is two times to four times, or more, time consuming and costly compared to human verification (e.g., of auto-labeled samples). In some cases, the auto-labeling approach may be a consensus-based auto-labeling paradigm using multiple models. Moreover, the process of tiered hardness and automatic labeling may use only one-fourth (¼th) to one-sixth (⅙th) of the time it would take to label from scratch a set of samples. In this manner, the second phase 106 may retrain the first model 104 using the different sets of labeled samples to produce the second model 108. In some cases, the second model 108 may achieve an accuracy of 70%, 80%, or 85%. For instance, for the CIFAR-10, the second model 108 may achieve an accuracy of 80-85%.

In some cases, the third phase 110 may include a process of targeted learning to provide a third model 112 (e.g., a near-perfect model). The process of targeted learning may have at least two components. The at least two components may include (1) automatic evaluation and error analysis and (2) targeted selection. The automatic evaluation and error analysis may search for “hard” and/or “rare” slices from a dataset (referred to as “targeting samples”). The targeted selection may select additional unlabeled samples similar to the targeting samples found by the automatic evaluation and error analysis (referred to, collectively, as targeting sample set). In this manner, the third phase 110 may retrain the second model 108 using the targeting sample set to produce the third model 112. For instance, for CIFAR-10, the third model 112 may be a model with 95%+ accuracy.

### Components of Labeling System

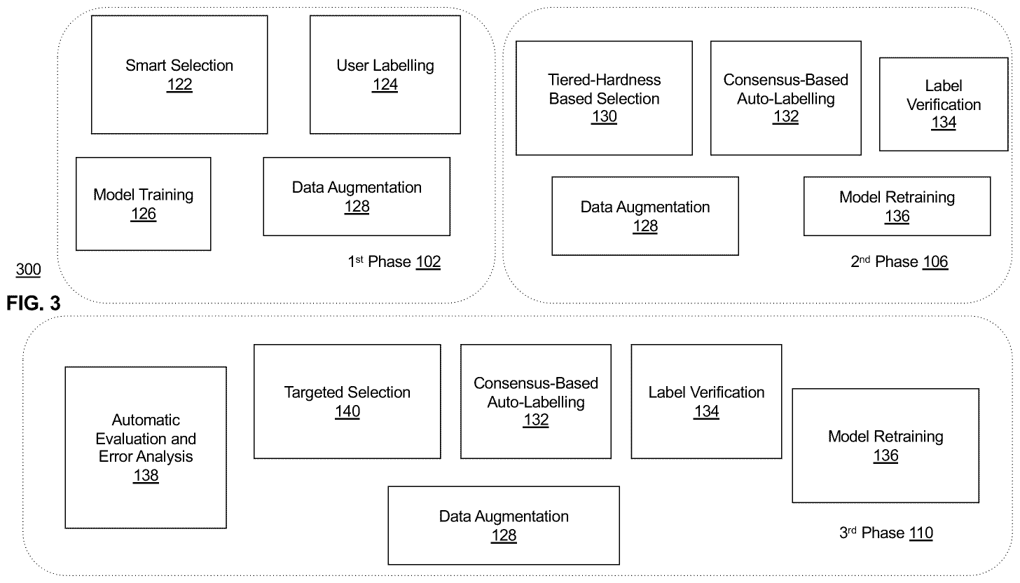

FIG. 3 shows a block diagram 300 of components of a labeling system 12c. The features of FIG. 3 may apply to any of FIGS. 1A, 1B, 2, 4, 5, 6, 7, 8, 9, 10, 11, 12, 13, and 14.

The block diagram 300, for the first phase 102, may include one or more of the following components: a smart selection component 122, a user labeling component 124, a model training component 126, and a synthetic data augmentation component 128. The smart selection component 122 may select a diverse and representative subset of data points to label from a set of training data (e.g., samples). The user labeling component 124 may enable user manual labeling from scratch of individual samples. The model training component 126 may perform initial data model training to obtain the first model 104, which may be used for subsequent iterations. The synthetic data augmentation component 128 may be used to increase the diversity and representation of training data (or re-training data) for the first model 104 (or the second model 108), e.g., in a limited label scenario. At the end of the first phase 102, the labeling system 12c may provide the first model 104.

The block diagram 300, for the second phase 106, may include one or more of the following components: a tiered-hardness based selection component 130, a consensus-based auto-labeling component 132, a label verification component 134, the synthetic data augmentation 128, and a model retraining component 136. The tiered-hardness based selection component 130 may select samples from the set of training data, such as easy, intermediate, and hard samples. The consensus-based auto-labeling component 132 may use multiple models to obtain consensus to label images automatically. The label verification component 134 may enable a user to verify if an auto-labeled label is correct or not; and, if not correct, fixes the label. In some cases, the consensus-based auto-labeling component 132 may also include an approach of using pseudo-labels from initial expert models along with consensus data to ensure labeling is done only for high-accuracy pseudo-labels. At the end of the second phase 106, the labeling system 12c may provide the second model 108.

The block diagram 300, for the third phase 110, may include one or more of the following: an automatic evaluation and error analysis component 138, a targeted selection component 140, the data augmentation component 128, the label verification component 134, and the model re-training component 136.

The automatic evaluation and error analysis component 138 may identify weaknesses in machine learning models by analyzing errors and low-confidence predictions. The automatic evaluation and error analysis component 138 may utilize auxiliary higher capacity models as pseudo-ground truth to evaluate the current model's performance, pinpointing instances of false positives, false negatives, and areas of confusion between classes. The automatic evaluation and error analysis component 138 may also discover semantically different test data instances, revealing the model's blind spots without the prerequisite of a labeled test set. By identifying challenging and rare data slices, the component aids in refining the model's accuracy, particularly in its ability to handle infrequent patterns, thereby streamlining the path towards achieving a near-perfect model.

The targeted selection component 140 may identify and select rare or challenging data samples that the machine learning model struggles with. By leveraging the set of error exemplars generated from the automatic evaluation and error analysis component 138, the targeted selection component 140 may mine the unlabeled dataset for additional instances that are conceptually similar to these hard examples. This targeted approach ensures that the training data is enriched with instances that are not just difficult but also diverse, thereby enhancing the model's ability to generalize and perform accurately on a wider range of scenarios. The component's ability to pinpoint and select these specific instances from a vast pool of unlabeled data is instrumental in refining the model's performance, particularly on the ‘long tail’ of the data distribution, and is a testament to the system's efficiency in guiding the development of a near-perfect model with minimized labeling effort.

As an example process between the three phases, the labeling system 12c may first perform the first phase 102, which includes smart selection using the smart selection component 122 and initial labeling using user labelling component 124. At the end of labeling, the labeling system 12c may train the first model 104 using the model training 126 (with or without data augmentation using the data augmentation component 128) to produce a trained first model 104. The first model 104 may have an accuracy of between 40-50%.

To further improve the model (e.g., with an accuracy of 90-95%), the labeling system 12c may loop through the following operations of the second phase 106. The labeling system 12c may use the tiered-hardness based selection component 130 to select samples of varying difficulty levels, which can then be fed into the consensus-based auto-labelling component 132 for automatic labeling. In some cases, the easy samples may not require human verification, but the intermediate and hard samples may require human verification and fixing, if necessary, using label verification component 134. Optionally, the data augmentation component 128 may be used to improve the diversity of the dataset. The labeled dataset may then be used to retrain the first model 104 using model retraining component 136. The labeling system 12c may repeat the hardness-based selection, auto-labeling, label verification, and retraining operations until the labeling system 12c determines a convergence condition is satisfied. In response to the convergence condition being satisfied, the labeling system 12c may provide the second model 108. For instance, the convergence condition may be an accuracy threshold (e.g., 80%+ accuracy).

The third phase 110 of the labeling system 12c may be configured to improve the model to produce the third model 112 by performing the following operations of the third phase 110. The labeling system 12c may search and find hard and/or infrequent patterns in the data, so that the model may increase performance on tail scenarios. The labeling system 12c may find samples which the model struggles in and to find the infrequent patterns which are hard to predict (“targeted samples”) using the automated evaluation and error analysis component 138. The labeling system 12c may pass the targeted samples into the targeted selection component 140, which is configured to search and find similar “hard” and/or “infrequent” samples in the unlabeled set. The targeted selection component 140 may mine for additional samples to address these rare scenarios. The labeling system 12c may pass the targeted samples and additional targeted samples (if any) to consensus-based auto-labelling component 132, which is configured to auto-label the targeted samples and additional targeted samples (if any). The labeling system 12c may determine whether auto-labels are correct based on verification and/or user input, and fixed by a human, using label verification component 134. Optionally, the labeling system 12c may use the data augmentation component 128. Finally, the labeling system 12c may retrain the second model 108 using the model retraining component 136 on the targeted samples and additional targeted samples (if any), their corresponding labels, any data augmentations, and the second model 108, to obtain the third model 112. At the end of the third phase 110, labeling system 12c may produce a near-perfect model, which performs very well on both the head and tail samples.

### First Phase of Labeling System

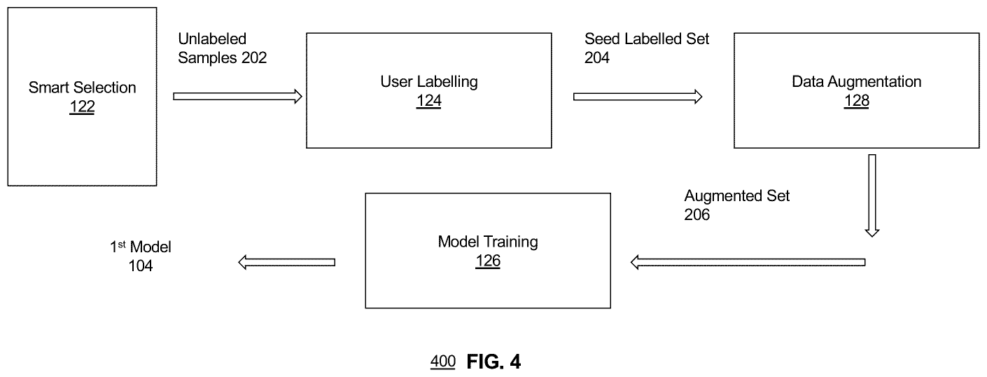

FIG. 4 depicts the workflow 400 of a first phase 102 of a labeling system 12c. The features of FIG. 4 may apply to any of FIGS. 1A, 1B, 2, 3, 5, 6, 7, 8, 9, 10, 11, 12, 13, and 14. In the workflow 400, the labeling system 12c may generate a representative and diverse initial labeled pool to train a first model 104. The workflow 400 of the first phase 102 may include the smart selection component 122, the user labeling component 124, the synthetic data augmentation component 128, and the model training component 126.

The labeling system 12c may use the smart selection component 122 to select unlabeled samples 202 from a training set of data (e.g., of unlabeled data). The labeling system 12c may use the user labeling component 124 to enable one or more users to manually label the unlabeled samples 202 to obtain a seed labelled set of samples 204. The labeling system 12c pass the seed labelled set of samples 204 to the synthetic data augmentation component 128, which is configured to modify the seed labelled set of samples 204 to obtain an augmented set of samples 206. The augmented set of samples 206 may be configured to be richer and more diverse, as compared to the seed labelled set of samples 204. The labeling system 12c may use the model training component 126 (e.g., training a deep learning model) to train the first model 104 using the seed labelled set of samples 204 or, optionally, the augmented set of samples 206.

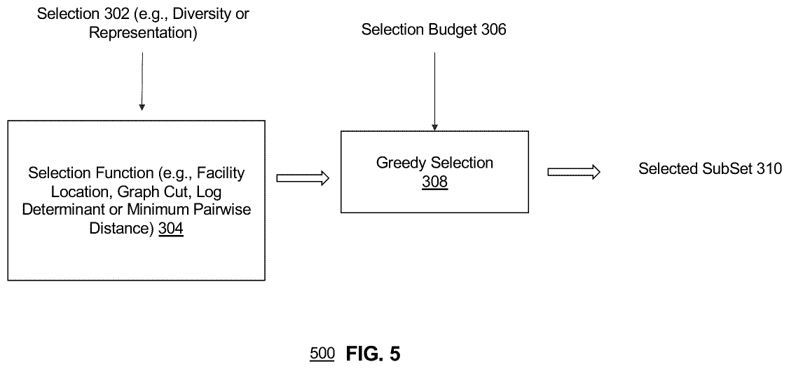

The smart selection component 122 may select the unlabeled samples 202 from the training set of data (e.g., of unlabeled data) using various functions and/or user-selections for types of selection. See FIG. 5 for further details.

Following the smart selection component 122, the user labeling component 124 may coordinate manual labeling of the unlabeled samples 202. For instance, the user labeling component 124 may provide a graphical user workflow, API interface, command line interface, or interact with uploaded user files, to receive annotations of the unlabeled samples 202. In some cases, the user labeling component 124 may be used to label data from scratch, meaning that human annotators can provide the first set of labels for these data without prior automated assistance or pre-labeled data. In this manner, the user labeling component 124 may ensure that the training data fed into the machine learning model is accurately labeled, thereby establishing a strong foundation for the model's learning.

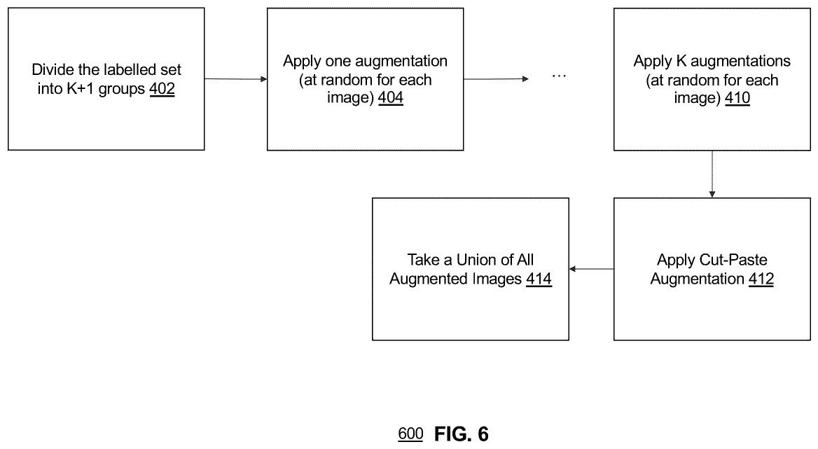

The synthetic data augmentation component 128 may modify the seed labelled set of samples 204 to obtain the augmented set of samples 206. See FIG. 6 for further details.

The model training component 126 may train an initial model on the seed labelled set of samples 204 or, optionally, the augmented set of samples 206, to obtain the first model 104. This operation involves feeding the newly labeled data into the initial model (e.g., a machine learning model) and updating the model based on differences between inferences and the labels, to create the first model 104. The first model 104 learns from the patterns, features, and relationships within the labeled data, which the first model 104 with the ability to make predictions or decisions when presented with new, unlabeled data.

### Smart Selection

FIG. 5 depicts a workflow 500 for a smart selection component 122. The features of FIG. 5 may apply to any of FIGS. 1A, 1B, 2, 3, 4, 6, 7, 8, 9, 10, 11, 12, 13, and 14.

In the workflow 500, the smart selection component 122 may select the unlabeled samples 202 from the training set of data (e.g., of unlabeled data) using various functions and/or user-selections for types of selection. As used herein, the phrase “smart selection” and variations thereof, refer to approaches which select diverse or representative set of examples for labeling. In some cases, the smart selection component 122 may use one or more types of smart selection approaches. For instance, the smart selection component 122 may select diversity selection and/or representation selection, as a selection function 304. Diversity selection, and variations thereof, may refer to approaches that capture a wide range of different and distinct variations of the dataset to ensure the model is exposed to the full spectrum of possible scenarios the model might encounter. Representative selection, and variations thereof, may involve choosing samples that reflect the overall distribution and characteristics of the entire dataset, thereby ensuring the model learns the most common trends and patterns. In some cases, the smart selection component 122 may receive a selection 302 from a user that selects between diversity selection or representation selection. In some cases, the smart selection component 122 may automatically select diversity selection or representation selection (e.g., based on metrics, etc. of the dataset).

The smart selection component 122 may use a submodular function (as the selection function 304), which is a set function that capture diversity and representation, to select the unlabeled samples 202. A submodular function ƒ is a set function defined on a ground set V which satisfies a diminishing returns property. The diminishing returns property may be defined by Equation 1. Equation 1:

$$f ( X ⋃ j ) - f ( X ) \geq f ( Y ⋃ j ) - f ( Y ) , ∀ X ⊆ Y ⊆ V$$

Examples of representation functions may include a facility location function, a graph cut function, and a saturated coverage function.

The facility location function may be defined by Equation 2. Equation 2:

$$f ( X ) = {\sum }_{i ∈ V} {max}_{j ∈ X} {s}_{i j}$$

The graph cut function may be defined by Equation 3. Equation 3:

$$f ( X ) = {\sum }_{i ∈ V} {\sum }_{j ∈ X} {s}_{i j} - λ {\sum }_{i , j ∈ X} {s}_{i j}$$

The saturated coverage function may be defined by Equation 4. Equation 4:

$$f ( X ) = {\sum }_{i ∈ V} min ( {\sum }_{j ∈ X} {s}_{i j} , α {\sum }_{j ∈ V} {s}_{i j} )$$

Intuitively, these functions try to find representative samples of a dataset when this function is maximized. If one thinks of this in terms of clustering, the representative data instances are the centroids of the clusters.

Examples of diversity functions may include the log determinant function and minimum pairwise distance function.

The log determinant function may be defined by Equation 5. Equation 5:

$$f ( X ) = log det {S}_{X}$$

The minimum pairwise distance function may be defined by Equation 6. Equation 6:

$$f ( X ) = {min}_{i , j ∈ X , i \neq j} {s}_{i j} .$$

These functions may model diversity and try to find diverse sets of data instances.

The facility location function, log determinant function, graph cut function, saturated coverage function, and the minimum pairwise distance function may be maximized, and can be efficiently performed using a greedy selection component 308.

The greedy selection component 308 may perform a greedy algorithm that receive as an input a selection budget 306, or the number of instances to select. The greedy algorithm, at every round, selects an instance j in the unlabeled set which maximizes a gain, which may be defined by Equation 7. Equation 7:

$$f ( X ⋃ j ) - f ( X )$$

The greedy algorithm continues until the selection budget is met. Once the selection budget is met, the smart selection component 122 may have the final selected subset 310 (e.g., the unlabeled samples 202). An important part of being able to label accurately (with minimal labeling errors) is to have a good initial labeled set. The framework 100 can select a diverse and representative seed labeled set in the way described above.

### Synthetic Data Augmentation

FIG. 6 depicts a workflow 600 for a synthetic data augmentation module 128. The features of FIG. 6 may apply to any of FIGS. 1A, 1B, 2, 3, 4, 5, 7, 8, 9, 10, 11, 12, 13, and 14.

In the workflow 600, the synthetic data augmentation component 128 may modify data (e.g., the seed labelled set of samples 204 to obtain the augmented set of samples 206) to generate augmented data. For instance, the synthetic data augmentation component 128 may generate labeled synthetic data to increase the diversity, richness, and quantity of labeled data without requiring more user labeling. The synthetic data augmentation component 128 may use various techniques to generate synthetic data, such as data augmentation. As used herein, data augmentation, and variations thereof, may refer to approaches that create synthetic data by perturbing the labeled data instances in a way as to not change the underlying labels or ground truth information. Examples of data augmentation used in computer vision and image processing can include random cropping, scaling and padding, horizontal flipping, lighting, brightness, contrast, hue, augmentation by adding different weather conditions, cut-paste augmentation where foreground objects were cut and place the foreground objects in different backgrounds, rotation and translation, and combinations thereof. All these augmentations help in increasing the number of labeled examples.

For example, the synthetic data augmentation component 128, at block 402, may first divide up the desired augmentation budget into K+1 groups. In some cases, K may be set or selected between two and five. At block 404, in the first group, the synthetic data augmentation component 128 may apply one augmentation selected at random from a list of augmentations. At block 410, the synthetic data augmentation component 128 may perform this process K times, so in Module K, the synthetic data augmentation component 128 can select K augmentations at random from the 8 augmentations above and apply the selected augmentation to the Kth group. At block 412, the synthetic data augmentation component 128 may apply a cut-paste augmentation to the (K+1)th group. At block 414, the synthetic data augmentation component 128 may take the union of all augmentations together and thereby generate the augmented dataset.

### Second Phase of Labeling System

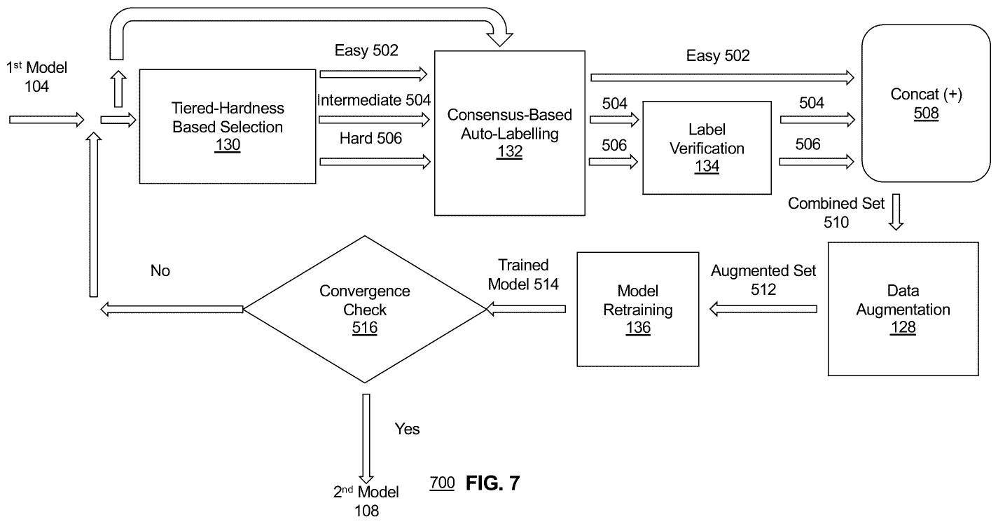

FIG. 7 depicts a workflow 700 of a second phase 106 of a labeling system 12c. The features of FIG. 7 may apply to any of FIGS. 1A, 1B, 2, 3, 4, 5, 6, 8, 9, 10, 11, 12, 13, and 14.

In the workflow 700, the labeling system 12c may receive the first model 104 and produce a second model 108 based on tiered-hardness selection and consensus-based labeling. The workflow 700 of the second phase 106 may include the tiered-hardness based selection component 130, the consensus-based auto-labelling component 132, the label verification component 134, a concatenation component 508, the data augmentation component 128, the model retraining component 136, and a convergence check component 516.

The workflow 700 may begin with the labeling system 12c receiving the first model 104 from the end of the first phase 102. The labeling system 12c may pass the first model 104 to the tiered-hardness based selection component 130.

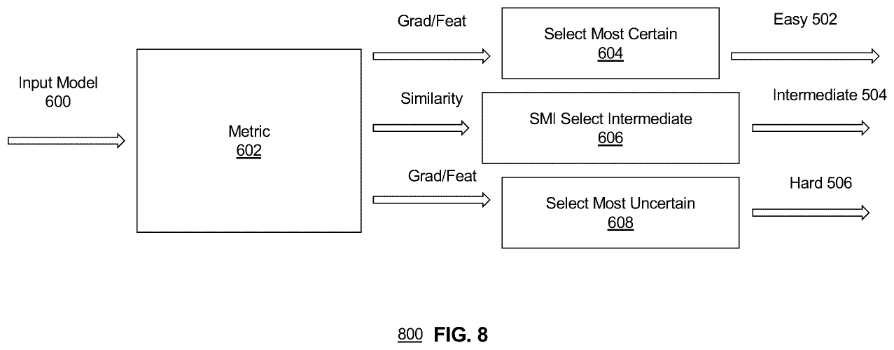

The tiered-hardness based selection component 130 may determine at least two kinds of subsets of unlabeled data. For instance, the at least two kinds of subsets of unlabeled data may include: a first subset 502 (e.g., easy), a second subset 504 (e.g., intermediate), and a third subset 506 (e.g., hard). The tiered-hardness based selection component 130 may pass all three subsets the consensus-based auto-labeling component 132. See FIG. 8 for further details.

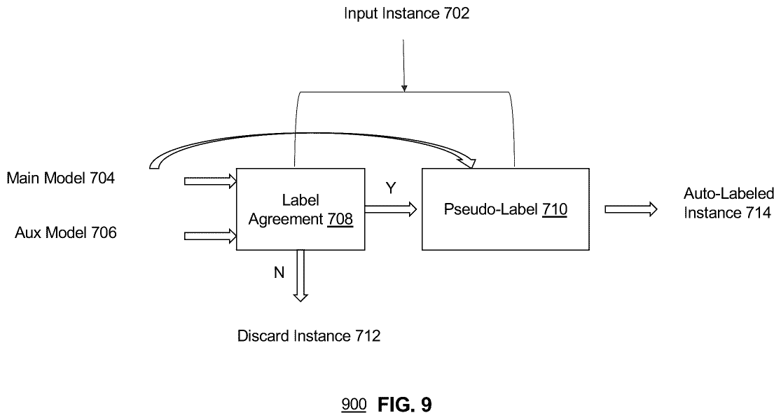

The consensus-based auto-labeling component 132 may provide labels for each data instance in an automatic manner without the need for human input. See FIG. 9 for further details. The first subset 502 may not require any human verification, while the second subset 504 and the third subset 506 may be passed to a human labeler who will verify the labels and fix mistakes, using the label verification component 134. A benefit of this arrangement is that the time taken for human verification and fixing may be much lower than labeling from scratch. The label verification component 134 may pass the second and third labelled subsets to the concatenation component 508, while the first subset, with auto-label, may be passed to the concatenation component 508 from the consensus-based auto-labeling component 132.

The concatenation component 508 may concatenate and combine the three labelled subsets into a combined labeled set 510. The concatenation component 508 may pass the combined labeled set 510 to the model retraining component 136, and/or, optionally, passed indirectly via the data augmentation component 128 to obtain labeled and augmented set 512. The data augmentation component 128 can be optional and need not be done every time.

The model retraining component 136 may retrain (or train, e.g., from scratch) the first model 104 to obtain a trained model 514. The model retraining component 136 may pass the trained model 514 to the convergence check component 516. If the convergence check component 516 determines that the trained model 514 has satisfied a second phase condition, the convergence check component 516 may output the trained model 514 as the second model 108. If not, the convergence check component 516 may repeat the process to update the trained model 514.

In some cases, the second phase condition may be an accuracy threshold (e.g., 90% accuracy), or a delta threshold for a difference in accuracy between a last iteration and the current iteration (e.g., a delta in performance). In some cases, the second phase condition may be a user indication that a user believes the model has obtained a level of performance. For instance, the delta threshold may automatically (or as a recommendation to the user) indicate a model which would not see significant improvements with further iterations. In some cases, the convergence check component 516 may track performance of each loop/iteration to determine a trend of performance (e.g., accuracy). Generally, based on observations, a model which achieves between a 70% to 80% accuracy on tasks like CIFAR-10 may be sufficiently re-trained to proceed from the second phase to the third phase.

The label verification component 134 may integrate human expertise to ensure the accuracy and reliability of labels assigned to the data, particularly in tasks like object detection and classification. The label verification component 134 may coordinate with a human reviewer to examine the labels, data, and associated metadata (e.g., bounding boxes in object detection tasks) that have been automatically generated by the labeling system 12c. For example, for object detection, the label verification component 134 may request a human to check both a location and dimensions of a bounding box to ensure it correctly identifies and encloses an object of interest, as well as verifying the object's label. In the case of classification, the label verification component 134 may request the human to confirm the accuracy of the assigned category. In the case of regression or ranking, the label verification component 134 may request a human to check the continuous label or ranking of the given instance. If discrepancies or errors are indicated by the human to the label verification component 134, the label verification component 134 corrects them, such as adjusting bounding boxes to encompass the object or changing the label more accurately to the correct class. In this manner, the intervention of a human in the loop may allow for the refinement of training data, as human-verified labels may be of higher quality than those generated automatically. By integrating the label verification component 134, the labeling system 12c may effectively harnesses human judgment to improve the dataset, which in turn may enhance the model's learning and performance.

The convergence check component 516 may ensure there is a significant increase in accuracy between iterations/loops. If the performance or accuracy has not improved, the convergence check component 516/user may decide to end the second phase and determine to proceed to the third phase. The convergence check component 516 may enable iterative process of model refinement by routing back to another iteration (for incremental improvement) or to proceed to the third phase. The convergence check component 516 may monitor and assess the performance improvements of a machine learning model after each round of data labeling and training. For example, the convergence check component 516 may evaluate whether iterations/loops of labeling and training have led to a statistically significant improvement in the model's accuracy. The convergence check component 516 may compare the model's performance metrics, such as accuracy, before and after the latest round of updates to the training data (or over several iterations/loops). If the convergence check component 516 determines that the most recent updates have not resulted in a meaningful enhancement of the model's performance (e.g., a delta+1% of metric), the convergence check component 516 may signal that the returns on further labeling and training are diminishing. At this juncture, the convergence check component 516 may prompt a user to make a decision: (1) continue the resource-intensive process of data labeling and model training or (2) conclude that the model has reached a plateau of performance. The convergence check component 516 may act as a checkpoint in a decision-making process in model life-cycle management, helping to prevent the wasteful allocation of resources on negligible gains, and signaling when it may be most efficient to transition from the active phase of model refinement to deployment or proceeding to the third phase.

### Tiered-Hardness Based Selection

FIG. 8 depicts an example workflow 800 of a tiered-hardness based selection component 130. The features of FIG. 8 may apply to any of FIGS. 1A, 1B, 2, 3, 4, 5, 6, 7, 9, 10, 11, 12, 13, and 14.

The tiered-hardness based selection component 130 may leverage the potential of human interaction in the data labeling process. The tiered-hardness based selection component 130 may adopt a tiered approach to data hardness, which categorizes data into three levels: hard, intermediate, and easy instances (e.g., third subset, second subset, and first subset, respectively). The tiered-hardness based selection component 130 may be configured to optimize a human contribution in the data labeling process. For instance, not all data instances contribute equally to a model's learning, and the tiered-hardness based selection component 130 may categorize the data instances based on a level of difficulty that the model has in making accurate predictions.

The tiered-hardness based selection component 130 may receive, as input, an input model 600. The tiered-hardness based selection component 130 use a metric component 602. The tiered-hardness based selection component 130 may pass the input model 600 to the metric component 602.

The metric component 602 may extract and determine features, gradients, and similarities. For instance, the metric component 602 may extract features, probability, or gradients (e.g., image features or textual features using the input model 600) of the unlabeled set. The metric component 602 may compute a similarity matrix using the features or gradients on the entire unlabeled dataset. In case the dataset is large, and the similarity matrix does not fit into memory, the metric component 602 may partition the unlabeled dataset into smaller blocks and obtain block wise similarity matrices. Collectively, the various metrics may be referred to as metric information.

The metric component 602 may pass the metric information to one or more types of selection functions 604, 606, and 608. For instance, the one or more types of selection functions 604, 606, and 608 may select easy, intermediate, and hard samples. The tiered-hardness based selection component 130 may use the selection functions 604, 606, and 608 and uncertainty for the selection. For instance, a submodular function for mutual information (SMI) function may be defined by Equation 8. Equation 8:

$${I}_{f} ( A ; Q ) = f ( A ) + f ( Q ) - f ( A ⋃ Q )$$

The SMI functions may enable selecting diverse set of points relevant to a given a query set Q. Furthermore, the tiered-hardness based selection component 130 may choose functions, so the tiered-hardness based selection component 130 may select from only relevance on one extreme to only diversity on the other. For instance, the tiered-hardness based selection component 130 may use a graph cut mutual information function, a facility location mutual information function.

The graph cut mutual information function may be defined by Equation 9. Equation 9:

$${I}_{f} ( A ; Q ) = {\sum }_{i ∈ X} {\sum }_{j ∈ Q} {s}_{i j}$$

The facility mutual information function may be defined in accordance with Equation 10. Equation 10:

$${I}_{f} ( A ; Q ) = {\sum }_{i ∈ X} {max}_{j ∈ Q} {s}_{i j} + {\sum }_{i ∈ Q} {max}_{j ∈ X} {s}_{i j} .$$

The graph cut mutual Information may model query relevance while the facility location mutual information may model both relevance and diversity.

For example, below is an explanation of one way to select easy, intermediate, and hard instances:

Easy Instances: These are data points where the current model has high confidence in its predictions. The model's confidence is typically quantified by the output probabilities, where higher probabilities suggest higher confidence. These instances can be considered ‘easy’ because the model is already capable of handling them correctly, and hence, they may not contribute significantly to the learning process. These easy instances may be completely auto-labeled. This easy instances may be assigned to the first subset.

Intermediate Instances: The selection of intermediate instances is a bit more sophisticated. The selection of intermediate instances may involve the use of a submodular mutual information function described above. This is a mathematical approach that measures the mutual information across different sets of data points, aiming to select a subset of data that is both diverse and informative for each class. By maximizing this function with respect to each class, the tiered-hardness based selection component 130 may effectively identify instances that provide a balance between relevance (e.g., how representative the instances are of their respective class) and diversity (e.g., how different they are from one another). This may help ensure that the model receives a wide variety of examples within each class, which are not the easiest but also not the most difficult to learn from, as the second subset.

Hard Instances: Hard instances may be selected based on the model's uncertainty and a diversity function applied to the gradients of the model. Uncertainty sampling involves choosing data points for which the model has low confidence in its predictions, indicating that it finds these instances difficult to classify. The diversity function on the gradients may examine the gradients (which represent how much a change in each parameter would affect the output) and select instances that are not only uncertain but also have diverse gradient profiles. This means that the selected hard instances, as the third subset, are not just the instances the model finds challenging but also those that would impact the learning of the model in diverse ways.

By adopting this tiered approach, the labeling system 12c may be concentrated where it's most needed: verifying and fixing more of the automatically generated labels of the hard and intermediate instances and automatically labeling the easy instances without human verification. In this manner, the labeling system 12c may make the labeling process and training process significantly more efficient (e.g., time, compute, human resources). Moreover, the labeling system 12c may also ensure that the model is fed with a balanced diet of challenges, fostering a more robust learning process.

### Consensus-Based Auto-Labelling

FIG. 9 depicts a workflow 900 of a consensus-based auto-labelling component 132. The features of FIG. 9 may apply to any of FIGS. 1A, 1B, 2, 3, 4, 5, 6, 7, 8, 10, 11, 12, 13, and 14.

In the workflow 900 for the consensus-based auto-labelling component 132, the consensus-based auto-labelling component 132 may use a label agreement component 708 and a pseudo-labeling component 710. As used herein, automatic labeling may refer to the approach of automatically labeling data instances either using multiple models or user provided rules. For instance, by using the labeled datasets in earlier phases, the model training component 126 (or the model retraining component 136) may generate a plurality of models. The plurality of models can be (a) of different architectures, and/or (b) trained with subsets of the labeled datasets. In some cases, the different architectures may be provided by users (e.g., proscribed by users or based on user selections), or automatically generated by the labeling system 12c. In some cases, the subsets of the labeled datasets maybe randomly selected. In some cases, a number of the subsets of the labeled datasets may be selected by a user or the labeling system 12c, and the allocation of data instances to each subset may be randomly assigned by the labeling system 12c. In this manner, the plurality of models obtained may be sufficiently different from each other model in the plurality of models (e.g., in architecture, training data, and/or combinations of both). The consensus-based auto-labelling component 132 may perform pseudo-labeling using the plurality of models, and, importantly, may obtain consensus from amongst the plurality of models.

The workflow 900 may depict the use of two models: a main model 704 and an auxiliary model 706. The main model 704 may be a model with a highest accuracy. The auxiliary model 706 may be one of the plurality of models. In some cases, the auxiliary model 706 may one of a plurality of auxiliary models (not depicted). In some cases, the auxiliary model 706 may be model with a next highest accuracy after the main model 704, or a model with a different architecture than the main model 704. The label agreement component 708 may be configured to keep only the data instances where there is high consensus, thereby reducing the amount of label noise in the labelling.

For instance, in the case of object detection, the label agreement component 708 may compute label agreement by taking spatially similar bounding boxes, and first ensure the predicted label is the same. If the label is the same, the label agreement component 708 can take an Intersection over Union (IOU) of the bounding boxes. Given two bounding boxes, the IOU is the intersection of these bounding boxes divided by the union of these bounding boxes. The final label agreement score (score) may be a combination of the label matchings (LM) and the mean IOU in the bounding boxes, as defined by Equation 11. Equation 11:

$$Score = LM + λ IOU$$

λ is an appropriately chosen trade-off parameter. In the case of regression, the score may be a L2 difference between the predicted values of the two models. In the case of simple classification, the label agreement component 708 may use the label matching.

The label agreement component 708 may compute the label agreement by ensuring that the difference in predictions, class matching for classification, L2 for regression, and mean IOU in object detection, are above a threshold. If the difference is above the threshold, the label agreement component 708 may pass the data instance to the pseudo-labeling component 710 for automatic labeling to generate an automatically labeled instance 714 (a set of such instances, a labeled set of instances 714). If the difference is below the threshold, the label agreement module 708 can remove discard instances 712 where the score is less than the defined threshold. The discarded instances 712 may be deemed “too difficult” to label and the human user may be invoked to manually label them.

Furthermore, below are two example workflows of the consensus-based auto-labelling component 132 in scenarios (i) where there is not a pre-trained model, and (ii) where there is a pre-trained model for auto-labeling.

Labeling without a Pre-trained Model: In cases where there is not a pre-trained model, the consensus-based auto-labelling component 132 may train the main model 704 and the auxiliary model 706 on a selected dataset. The labeled set can then be trained and will produce multiple models-one main model and one or more auxiliary models for consensus. Note that since there is not a pre-trained model, the models for labeling and consensus may be obtained from the same labeled set. At a minimum two models may be used, one main model and one auxiliary model, but more than two models can be used in certain embodiments (e.g., more than one auxiliary model). The main and auxiliary models are then passed to the label agreement component 708, which can then label the data instances where there is a high overlap (each individual data instance being an input instance 702). The consensus-based auto-labelling component 132 can then obtain a final set which is a combination of the user-labeled and generated label datasets, the consensus-based auto-labelling component 132 can perform final model training, and generate a final trained model.

Labeling with a Pre-trained Model: In cases where there is a pre-trained model with an overlapping set of classes (for example, if a system wants to detect people and vehicles, the labeling component can use a pre-trained coco object detection model and just use the class people and vehicles), the consensus-based auto-labelling component 132 may directly use the pre-trained model for labeling without needing to train a labeling model on an initial labeled set. Optionally, the user can add a manually labeled dataset to the labeled set from the pre-trained models. The consensus-based auto-labelling component 132 may take a plurality of pre-trained models and perform consensus-based labeling with the plurality of pre-trained models on the unlabeled set and obtain a labeled set. The consensus-based auto-labelling component 132 may combine the user-labeled set and the generated labeled set and get the final set which the labeling component can then train and obtain the final model.

### Third Phase of Labeling System

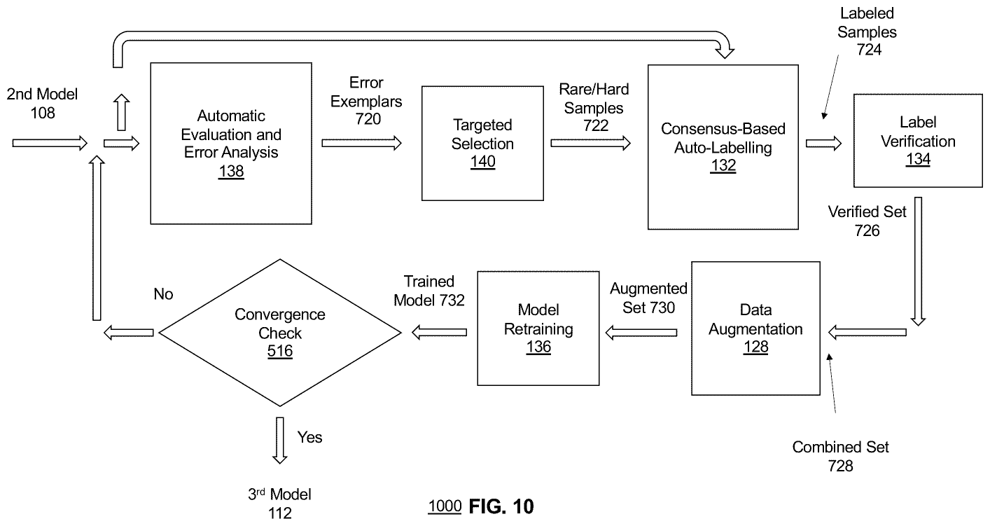

FIG. 10 depicts a workflow 1000 for a third phase 110 of a labeling system 12c. The features of FIG. 10 may apply to any of FIGS. 1A, 1B, 2, 3, 4, 5, 6, 7, 8, 9, 11, 12, 13, and 14.

In the workflow 1000, the labeling system 12c may receive a second model 108 and produce a third model 112 based on automatic evaluation, error analysis, and targeted selection. The workflow 1000 of the third phase 110 may include the automated evaluation and error analysis component 138, the targeted selection component 140, the consensus-based auto-labelling component 132, the label verification component 134, the data augmentation component 128, the model retraining component 136, and the convergence check component 516.

The workflow 1000 may begin with the labeling system 12c receiving the second model 208 from the second phase 106. The second model 208 typically tends to do well on head slices and classes (e.g., the more frequent data) but may perform decent or poorly on tail slices. The goal of the third phase 110 may be to use error analysis and automatic evaluation to find the challenging and hard data slices, and use targeted selection to mine more unlabeled data belonging to such slices. The challenging and hard data slices may then auto-labeled and verified, and finally passed through a model training (e.g., after data augmentation).

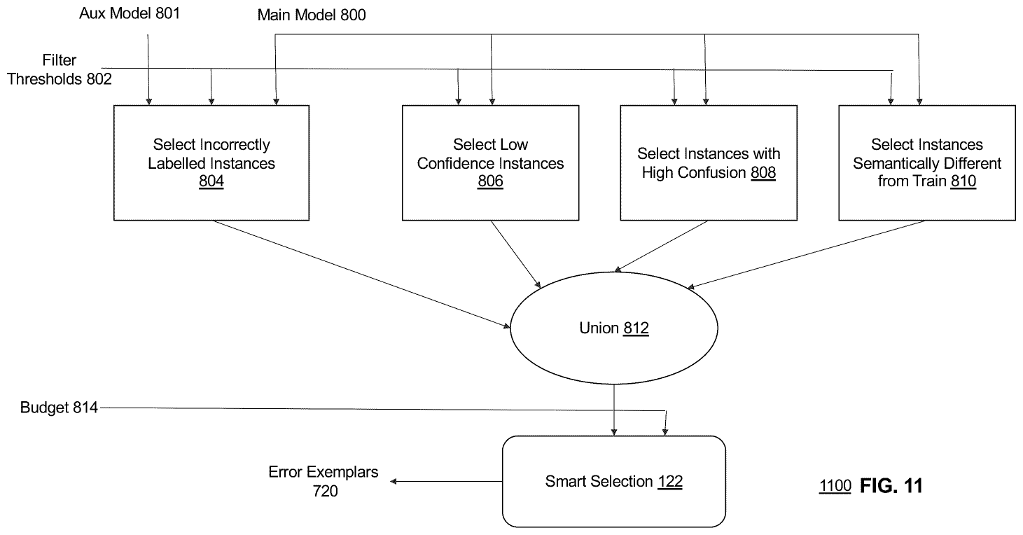

The automated evaluation and error analysis component 138 may receive the second model 108 from the second phase 106. The automated evaluation and error analysis component 138 may determine a set of error exemplars 720. See FIG. 11 below. The automated evaluation and error analysis component 138 may pass the set of error exemplars 720 to the targeted selection component 140. Error exemplars may refer to samples that the automated evaluation and error analysis component 138 determines are likely that the model will mistake. The automated evaluation and error analysis component 138 may operate on unlabeled data—that is, the automated evaluation and error analysis component 138 does not require labeled data to find errors.

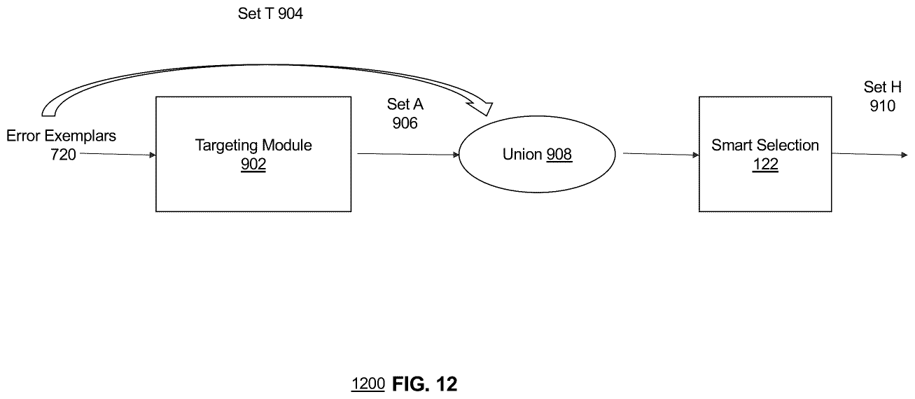

The targeted selection component 140 may receive the set of error exemplars 720 and mine for similar error samples. See FIG. 12 below. The targeted selection component 140 may be configured to enrich the training data with rare and infrequent patterns that the model is struggling with to infer correctly. These are typically not easily found by just random sampling because the rare and infrequent patterns may be akin to finding a needle in a haystack. The targeted selection component 140 may search and find (if any) more examples of rare and hard samples like the error exemplars 720 to obtain additional samples 722 based on the set of error exemplars 720. The set of error exemplars 720 and the additional samples 722 (if any) may be passed to the consensus-based auto-labelling component 132 for automatic labeling (to generate labeled samples 724) and then to label verification component 134 (to generate a verified set 726). In some cases, the labeling system 12c may combine the verified set 726 with other data instances (e.g., easy data instances) to form a combined set 728. The labeling system 12c may pass the verified set 726 and/or the combined set 728 to the model retraining component 136, or, optionally, indirectly via the data augmentation component 128. The data augmentation component 128 may generate an augmented set 730 based on the verified set 726 and/or the combined set 728. After the optional data augmentation by the data augmentation component 128, the labeling system 12c may retrain the model, using the model retraining component 136, to produce a trained model 732. In this case, the model retraining component 136 may use at least the error exemplars 720 and (if any) the additional samples 722 to re-train the model to obtain a trained model 732.

The labeling system 12c may then proceed to the convergence check component 516. For instance, the convergence check component 516 may determine whether there is an improvement of the model on a held-out validation set. If the model satisfied a third phase condition (e.g., converged or reached a third process threshold or upon user indication), the labeling system 12c may determine the training model 732 is a third model 112. In this manner, the third model 112 may capture most of the infrequent patterns in the data. If model does not satisfy the third phase condition, the labeling system 12c may repeat the third phase 110 process. For instance, the third phase 110 process may loop to find new kinds of infrequent or rare patterns for targeted selection.

### Automated Evaluation and Error Analysis

FIG. 11 depicts a workflow 1100 for an automated evaluation and error analysis component 138. The features of FIG. 11 may apply to any of FIGS. 1A, 1B, 2, 3, 4, 5, 6, 7, 8, 9, 10, 12, 13, and 14.

The workflow 1100 of the automated evaluation and error analysis component 138 may use auxiliary higher capacity models 801 as pseudo-ground truth for one or more evaluation components, such as a model evaluation component 804, a find low confidence instances component 806, a find confusing instances with label overlaps component 808, and an obtain semantically different test data instances on which the model will fail with high probability component 810. The user or the labeling system 12c may select thresholds 802 for the evaluation components. The automated evaluation and error analysis component 138 may obtain subsets using filter conditions based on the thresholds 802 for each of the evaluation components. The automated evaluation and error analysis component 138 can take a union 812 of all subsets obtained from the evaluation components. The automated evaluation and error analysis component 138 may obtain the error exemplars 720 via the smart selection component 122 on a budget 814. See, e.g., FIG. 5. For instance, the budget 814 may be selected by the user and/or the labeling system 12c. The error exemplars 720 may be passed to the targeted selection component 140. A diverse set of instances can be selected from the filtered set so as to remove redundancy and also provide a manageable set of instances to the user which the user can then label or target. The automated evaluation and error analysis component 138 may perform diversity selection using a submodular function (like facility location or log determinant function) and maximizing the function, as discussed herein with the smart selection component 122. The automated evaluation and error analysis component 138 may create a summary of a preset size or desired size (e.g., as set by the user or the labeling system 12c).

The automated evaluation and error analysis component 138 may evaluate a current candidate model using an auxiliary (e.g., higher capacity) model. Metrics such as false positives, false negatives, precision, recall, thresholding, receiver operating characteristic curves (ROC curves), and combinations thereof can be computed for the current candidate model. Additionally, the current candidate model can also compute the number of low confidence instances in the unlabeled test set along with potential label confusions. The labeling system 12c may automatically discover test data instances that are semantically different from the training data, to uncover blind spots in the model. The blind spots may include missing slices or even missing classes in the unlabeled data which have not been considered during the initial labeling. The automated evaluation and error analysis component 138 may determine hard and difficult test examples without needing a labeled test set. As a result, the automated evaluation and error analysis component 138 may be used on data from any downstream deployment scenario. Once the labeling system 12c finds the hard test examples using the automated evaluation and error analysis component 138, the labeling system 12c may use the targeted selection component 140, to find similar instances in a large unlabeled data pool. As discussed herein, the automated evaluation and error analysis component 138 and target selection component 140 may be repeated to further improve the accuracy of the model.

The automated evaluation and error analysis component 138 may enable evaluation of a machine learning model, which may enable understanding how well the model performs in real-world deployment scenarios. However, for achieving trustworthy results, the set to be tested needs to be “held-out”, which means that no part of the training pipeline should use this data. Most commonly in machine learning, the test set is also labeled, and usually a user has to label an evaluation set. Furthermore, if part of the labeled test set is used to correct the model errors (e.g., finding the most erroneous examples and then having a model train on those error examples), a new labeled test set may be used because the training and labeling process has now seen the previous set of examples.

To alleviate the difficulties of having a labeled test set, the automated evaluation and error analysis component 138 may use auxiliary higher capacity models 801 as pseudo-ground truth for model evaluation to: find and select data instances that were incorrectly labeled instances (e.g., 804); find and select data instances with low confidence instances (e.g., 806); find and select confusing instances with label overlaps (e.g., 808); and find and select semantically different test data instances on which the model will fail with high probability (e.g., 810).

In a first approach for automatic evaluation, the automated evaluation and error analysis component 138 may use pseudo-ground truth labels from a higher capacity model, such as the auxiliary model 801. The higher capacity model may be trained on the same dataset but because the model has a higher capacity (e.g., model parameters, size), the auxiliary model 801 may be expected to be more accurate. The automated evaluation and error analysis component 138 can compare pseudo-labels to those output by the main model 800 (e.g., a current second model 108). The automated evaluation and error analysis component 138 may compute the false positives (objects found in the higher capacity model but not captured by the current model to be evaluated) and false negatives (objects found in the current model to be evaluated but not found in the higher capacity model). Because the automated evaluation and error analysis component 138 may use the auxiliary model 801, there may be instances that certain objects are missed even by the auxiliary model 801, and some of the objects may be incorrectly detected by the auxiliary model 801. To partially alleviate this, the automated evaluation and error analysis component 138 may also provide a mechanism for the user to correct critical mistakes made by the auxiliary model 801. The automated evaluation and error analysis component 138 may obtain the main model 800 and the auxiliary model 801 from the model training component 126 (e.g., the plurality of models).

In the alternative or in addition to using high-capacity models, the automated evaluation and error analysis component 138 may also use model confidence about the predictions and detections to find low confidence data instances 806. The automated evaluation and error analysis component 138 may use predicted probability and confidence, using metrics like uncertainty and entropy, or combinations thereof. The low confidence data instances may be likely instances where the model is struggling. The number of low confidence predictions can give an indication of how well the model performs and how confident the model is on unseen test data instances.

In addition to low confident data instances, the automated evaluation and error analysis component 138 can find test data instances where the model is confused between classes 808. In the case of object detection, confused test data instances tend to be objects where there are multiple overlapping bounding boxes of different classes (i.e., the model confuses a specific foreground object with two or more classes). In the case of classification, the automated evaluation and error analysis component 138 may use the concept of margin—the lower the margin (difference between the two most confident predictions), the higher the model confusion.

In cases where the training set for the model is known, the automated evaluation and error analysis component 138 may find semantically different test examples that have not been seen by the model while training 810. For example, in the case of object detection in autonomous driving, the model could be trained on regular weather conditions, but the test set could have examples from heavy rain or fog. In such cases, the automated evaluation and error analysis component 138 can select these harder test examples as being semantically different from the training set. To do this, the automated evaluation and error analysis component 138 may use submodular functions. For instance, the submodular functions may a conditional gain function. Given the training dataset T, the automated evaluation and error analysis component 138 may find a set X which maximizes an equation defined by Equation 12. Equation 12:

$$f ( X \vert T ) = f ( X ⋃ T ) - f ( T )$$

Alternatively, the conditional gain of adding the set X to the training dataset T, the larger the conditional gain function, the more different the set X is from the training dataset T. In some cases, the automated evaluation and error analysis component 138 may use the facility location function conditional gain function and the graph cut conditional gain function.

### Targeted Selection Component

FIG. 12 depicts a workflow 1200 for a targeted selection component 140. The features of FIG. 12 may apply to any of FIGS. 1A, 1B, 2, 3, 4, 5, 6, 7, 8, 9, 10, 11, 13, and 14.

In the workflow 1200 for the targeted selection component 140, the targeted selection component 140 may search and find (if any) hard scenarios that be selected using the set of error exemplars 720. Given the hard instances in the set of error exemplars 720, the labeling system 12c can mine the unlabeled data to answer the following question: “Are there similar harder scenarios in the unlabeled set, that can then be mined and added to the training dataset?”. As an example, the model can be blind to scenarios like “foggy or rainy weather”, or harder slices like “motorcyclist at night on a highway”. Using the automated evaluation and error analysis component 138, the labeling system 12c has discovered a few exemplars of such hard and problematic scenarios (e.g., set of error exemplars 720). The labeling system 12c can then target and mine these scenarios using the targeted selection component 140.

The targeted selection component 140 may receive set of error exemplars 720 (e.g., hard examples, referred to as set T 904). The set T 904 can be passed into a targeting module 902, described below. The targeting module 902 can select a set A 906 (which can be a subset of the unlabeled dataset) which can be semantically similar to the input set of error exemplars 720, set T 904. The targeted selection component 140 can then take a union 908 of set A 906 and set T 904 and achieve a set A U T. The targeted selection component 140 may perform smart selection using the smart selection component 122 (e.g., diversity selection) on the set of A U T depending on a labeling budget (e.g., the user or system can provide) and obtain a set H 910 of hard examples. For example, imagine that using the evaluation component 138, the system/user may determine one hundred hard instances which can become the set T 904. The targeted selection component 140 may then use, e.g., SMI functions to obtain another one hundred examples (e.g., the set A 906) which are conceptually similar to set T 904 and, thus, will also be hard instances. If the labeling budget from the user (or system) is one hundred, the targeted selection component 140 may perform a diversity selection from A U T and to obtain a diverse subset H of 100 examples which the user can then label.

### Targeting Module

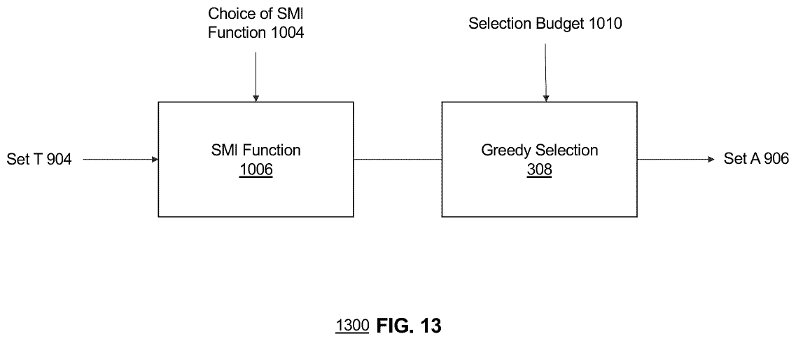

FIG. 13 depicts a workflow 1300 of a targeting module 902 in the targeted selection component 140. The features of FIG. 13 may apply to any of FIGS. 1A, 1B, 2, 3, 4, 5, 6, 7, 8, 9, 10, 11, 12, and 14.

The workflow 1300 may depict the targeting module 902 in the targeted selection component 140 processing set T 904 to obtain a set A 806. Based on a user (or system) selection 1004, the targeting module 902 may instantiate a submodular function. For instance, given a submodular function ƒ, the targeting module 902 can define a mutual information function called the submodular mutual information (SMI) 1006 as defined by Equation 13. Equation 13:

$${I}_{f} ( A ; T ) = f ( A ) + f ( T ) - f ( A ⋃ T )$$

Intuitively, this function can capture joint information between the sets A and T as captured by the underlying submodular function. Examples of SMI functions include the facility location mutual information, graph cut mutual information, and log determinant mutual information. In one example, the set T is the target set and can include the hard examples obtained from the evaluation component. Maximizing I_{ƒ}(A; T) for a given set T will yield a set A which is semantically and conceptually similar to T but also diverse in itself. In an example, the set T is the set of instances in “foggy weather”, or “rainy weather”, or “motorcyclists at night”. Then by maximizing the submodular mutual information, the targeting module 902 can obtain a diverse set of examples from a large unlabeled set which are similar conceptually to T. Thereby even if the target set T is a small sample of hard examples, using the SMI functions, the targeting module 902 can enhance training data by obtaining other hard examples. Given the choice of the SMI function 1004, the targeting module 902 can instantiate the SMI function 1006. Then given the selection budget 1010 (e.g., user or system provided), the targeting module 902 can perform a greedy selection algorithm (e.g., using the greedy selection component 308) to achieve a diverse set A 906, which is semantically similar to the set T 904.

### Case Studies

In the sections below, the present disclosure outlines example case studies where the labeling system 12c has been used. In each case, the present disclosure provides the time and cost savings enabled through the use of the labeling system 12c.

Case Study 1—Autonomous Driving: In the autonomous driving domain, the labeling system 12c significantly enhances the object detection process on roads by maximizing performance with minimal data and reduced human effort. In the first phase 102, the labeling system 12c is able to create a “basic model” with a 37% accuracy. Specifically, diverse selection picks four hundred images, split evenly between training and evaluation, requiring full human labeling but starting performance at 22%. The data augmentation may then generate four hundred synthetic images from one hundred real ones, boosting performance to 37% without additional human labor. Subsequently, In the second phase 106, the automatic labeling and tiered hardness-based selection, incrementally select and process one hundred and fifty images at a time, correcting auto-labels with decreasing human intervention from 50% to 40%, and then to 25%, progressively improving performance from 55.3% to a final 74%. Finally, using the third phase 110, the labeling system 12c can further refine the model by selecting more of the rare class images, and in two steps, brings the performance from 74% to 90%. Each phase tactically refines the dataset, addressing weak points, imbalances, and enhancing overall model accuracy with strategic human input. The labeling system 12c may reduce the number of required labels and the labeling time by a staggering ten times—the user needs to label only six hundreds images while more than six thousand images would be required without the intelligent selection and phased learning approach of the labeling system 12c.

Case Study 2—Medical Imaging: In the realm of medical imaging, labeling system 12c may revolutionize lesion detection through its sophisticated computer vision system, enhancing early disease diagnosis and patient outcomes. Beginning with the first phase 102, diverse selection and data augmentation produces a “basic” model with an accuracy of 31% with three hundred images manually labeled. Using the tiered-hardness selection and automatic labeling, labeling system 12c may enhance the performance from 31% to 65.3% after multiple rounds of label verification and fixing. The human labeling effort progressively reduces from 50% to 25% as the labeling system 12c selects more images to address complex scenarios. Finally, using the third phase 110 of labeling system 12c, the labeling system 12c may reach an accuracy of 91% using targeted selection and automatic labeling. The labeling system 12c only needs nine hundred images while more than twelve thousand images would be required to reach the same accuracy if they were randomly selected, resulting in a fourteen times reduction in time and labeling cost.

Case Study 3—Powerline Inspection: The labeling system 12c enhances powerline defect detection with AI-driven training techniques that significantly improves grid maintenance. Initially, four hundred images were handpicked, divided evenly for training and evaluation in the first phase 102, which resulted in a “basic model” with a 29% accuracy. In the first phase 102, the labeling system 12c used diverse selection with manual labeling and data augmentation. In the second phase 106, using the tiered-hardness based selection along with automatic labeling, the labeling system 12c increased the performance from 29% to 42%, 51% and eventually 64%, each time requiring fewer label corrections after the automatic labeling. In the third phase 110, the labeling system 12c used targeted selection to target the model's weak spots and balance the label distribution. This increased the performance from 64% to 94% after three rounds. The labeling system 12c just needed the labeling of eight hundred images, which is a fifteen times reduction compared to random selection and labeling.

### Computer System

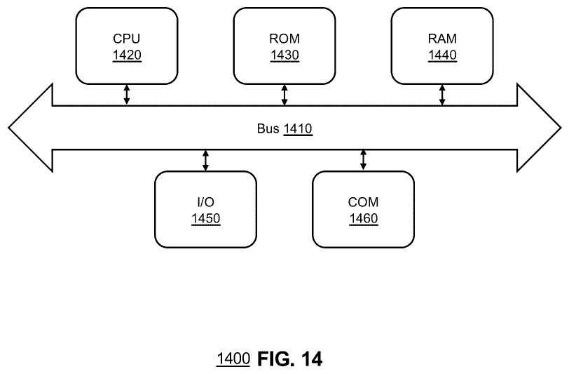

FIG. 14 depicts an example system that may execute techniques presented herein. FIG. 14 is a simplified functional block diagram of a computer that may be configured to execute techniques described herein, according to exemplary cases of the present disclosure. Specifically, the computer (or “platform” as it may not be a single physical computer infrastructure) may include a data communication interface 1460 for packet data communication. The platform may also include a central processing unit (“CPU”) 1420, in the form of one or more processors, for executing program instructions. The platform may include an internal communication bus 1410, and the platform may also include a program storage and/or a data storage for various data files to be processed and/or communicated by the platform such as ROM 1430 and RAM 1440, although the system 1400 may receive programming and data via network communications. The system 1400 also may include input and output ports 1450 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In some cases, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

### Terminology

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of +10% in a stated value.

The term “exemplary” is used in the sense of “example” rather than “ideal.” As used herein, the singular forms “a,” “an,” and “the” include plural reference unless the context dictates otherwise.

### EXAMPLES

Exemplary embodiments of the systems and methods disclosed herein are described in the numbered paragraphs below.
A1. A system for adaptive data labelling to enhance machine learning precision, comprising:
one or more memories configured to store instructions; and
one or more processors configured to, when executing the instruction, perform operations for a plurality of components, wherein the plurality of components include:
   a smart selection component configured to select a subset of unlabeled data;
   a user labeling component configured to enable a user to manually label the selected subset of unlabeled data;
   a model training component configured to train a machine learning model using the labeled subset of data;
   a tiered-hardness based selection component configured to select data samples based on hardness tiers;
   a consensus-based auto-labeling component configured to automatically label the selected data samples;
   an automatic evaluation and error analysis component configured to identify weaknesses in the machine learning model; and
   a targeted selection component configured to select additional unlabeled data samples similar to the identified weaknesses.
A2. The system of A1, wherein the smart selection component is configured to select the subset of unlabeled data based on a diversity selection function or a representative selection function.
A3. The system of A2, wherein the diversity selection function is configured to select data instances that capture a wide range of different and distinct variations of the dataset.
A4. The system of A2, wherein the representative selection function is configured to select data instances that reflect the overall distribution and characteristics of the dataset.
A5. The system of A1, wherein the tiered-hardness based selection component is configured to select data samples based on at least three hardness tiers, including a first hardness tier for easy samples, a second hardness tier for intermediate samples, and a third hardness tier for hard samples.
A6. The system of A5, wherein the consensus-based auto-labeling component is configured to automatically label the easy samples without human verification, and to automatically label the intermediate and hard samples with human verification.
A7. The system of A1, wherein the automatic evaluation and error analysis component is configured to identify weaknesses in the machine learning model by analyzing errors and low-confidence predictions of the machine learning model.
A8. The system of A1, wherein the targeted selection component is configured to select additional unlabeled data samples that are conceptually similar to the identified weaknesses.
A9. The system of A1, further comprising a data augmentation component configured to modify the labeled subset of data to increase the diversity, richness, and quantity of labeled data.
A10. A computer-implemented method for adaptive data labelling to enhance machine learning precision, the computer-implemented method comprising:
selecting a subset of unlabeled data;
enabling a user to manually label the selected subset of unlabeled data;
training a machine learning model using the labeled subset of data;
selecting data samples based on hardness tiers;
automatically labeling the selected data samples;
identifying weaknesses in the machine learning model; and selecting additional unlabeled data samples similar to the identified weaknesses.
A11. The computer-implemented method of A10, wherein the selecting of data samples based on hardness tiers includes categorizing the data samples into at least three categories comprising easy, intermediate, and hard samples, and wherein the automatically labeling of the selected data samples is performed without human verification for easy samples and with human verification for intermediate and hard samples.
A12. The computer-implemented method of A10, further comprising augmenting the labeled subset of data using data augmentation techniques to increase the diversity and richness of the labeled data, wherein the data augmentation techniques include at least one of random cropping, scaling and padding, horizontal flipping, adjusting lighting, brightness, contrast, hue, or adding synthetic weather conditions.
B1. An adaptive data labeling system comprising of (i) a smart selection and initial labeling component, (ii) a tiered hardness based selection and consensus based automatic labeling component, and a targeted selection and automatic labeling component.
B2. The adaptive data labeling system of B1, further comprising one or combinations of: a data selection component configured to select a subset of unlabeled data for initial human labeling; a data augmentation component configured to augment the labeled data with various data transformations to increase the amount of labeled data; a user labeling component, wherein a user labels the selected data instances; a consensus based labeling component configured to use pseudo-labels from multiple models for consensus; a tiered hardness based selection component, a model training and refinement component configured to train the models on the user labeled and system labeled instances; a targeted selection component, and an evaluation and validation component.
B3. The adaptive data labeling system of B2, wherein the data selection component is configured to select a subset of diverse and representative data instances using submodular functions as choices of diversity functions.
B4. The adaptive data labeling system of B2, wherein the data augmentation component is configured to perform random cropping, scaling and padding, horizontal flipping, lighting, brightness, contrast, hue, augmentations by adding different weather conditions, and combinations thereof.
B5. The adaptive data labeling system of B2, wherein the tiered hardness component is configured to select instances which are easy and can be automatically labeled, instances of intermediate hardness and that require a mix of human verification and automatic labeling, and instances of hard instances and that require manual labeling.
B6. The adaptive data labeling system of B2, wherein the consensus based labeling component is configured to use multiple machine learning models and use a consensus mechanism to only label the high confidence data instances.
B7. The adaptive data labeling system of B2, wherein scenarios of existing pretrained models, and without unlabeled data, can be directly labeled using multiple pre-trained models.
B8. The adaptive data labeling system of B2, wherein the adaptive data labeling system selects examples given an initial labeled set, a labeling model, and an unlabeled data pool using mechanisms of diversity and uncertainty.

Other aspects of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for adaptive data labelling to enhance machine learning precision, comprising:
one or more memories configured to store instructions; and
one or more processors configured to, when executing the instruction, perform operations for a plurality of components, wherein the plurality of components include:
a smart selection component configured to select a subset of unlabeled data;
a user labeling component configured to enable a user to manually label the selected subset of unlabeled data;
a model training component configured to train a machine learning model using the labeled subset of data;
a tiered-hardness based selection component configured to select data samples based on hardness tiers;
a consensus-based auto-labeling component configured to automatically label the selected data samples;
an automatic evaluation and error analysis component configured to identify weaknesses in the machine learning model; and
a targeted selection component configured to select additional unlabeled data samples similar to the identified weaknesses.

2. The system of claim 1, wherein the smart selection component is configured to select the subset of unlabeled data based on a diversity selection function or a representative selection function.

3. The system of claim 2, wherein the diversity selection function is configured to select data instances that capture a wide range of different and distinct variations of the dataset.

4. The system of claim 2, wherein the representative selection function is configured to select data instances that reflect the overall distribution and characteristics of the dataset.

5. The system of claim 1, wherein the tiered-hardness based selection component is configured to select data samples based on at least three hardness tiers, including a first hardness tier for easy samples, a second hardness tier for intermediate samples, and a third hardness tier for hard samples.

6. The system of claim 5, wherein the consensus-based auto-labeling component is configured to automatically label the easy samples without human verification, and to automatically label the intermediate and hard samples with human verification.

7. The system of claim 1, wherein the automatic evaluation and error analysis component is configured to identify weaknesses in the machine learning model by analyzing errors and low-confidence predictions of the machine learning model.

8. The system of claim 1, wherein the targeted selection component is configured to select additional unlabeled data samples that are conceptually similar to the identified weaknesses.

9. The system of claim 1, further comprising a data augmentation component configured to modify the labeled subset of data to increase the diversity, richness, and quantity of labeled data.

10. A computer-implemented method for adaptive data labelling to enhance machine learning precision, the computer-implemented method comprising:
selecting a subset of unlabeled data;
enabling a user to manually label the selected subset of unlabeled data;
training a machine learning model using the labeled subset of data;
selecting data samples based on hardness tiers;
automatically labeling the selected data samples;
identifying weaknesses in the machine learning model; and
selecting additional unlabeled data samples similar to the identified weaknesses.

11. The computer-implemented method of claim 10, wherein the selecting of data samples based on hardness tiers includes categorizing the data samples into at least three categories comprising easy, intermediate, and hard samples, and wherein the automatically labeling of the selected data samples is performed without human verification for easy samples and with human verification for intermediate and hard samples.

12. The computer-implemented method of claim 10, further comprising augmenting the labeled subset of data using data augmentation techniques to increase the diversity and richness of the labeled data, wherein the data augmentation techniques include at least one of random cropping, scaling and padding, horizontal flipping, adjusting lighting, brightness, contrast, hue, or adding synthetic weather conditions.

13. An adaptive data labeling system comprising of (i) a smart selection and initial labeling component, (ii) a tiered hardness based selection and consensus based automatic labeling component, and a targeted selection and automatic labeling component.

14. The adaptive data labeling system of claim 13, further comprising one or combinations of: a data selection component configured to select a subset of unlabeled data for initial human labeling; a data augmentation component configured to augment the labeled data with various data transformations to increase the amount of labeled data; a user labeling component, wherein a user labels the selected data instances; a consensus based labeling component configured to use pseudo-labels from multiple models for consensus; a tiered hardness based selection component, a model training and refinement component configured to train the models on the user labeled and system labeled instances; a targeted selection component, and an evaluation and validation component.

15. The adaptive data labeling system of claim 14, wherein the data selection component is configured to select a subset of diverse and representative data instances using submodular functions as choices of diversity functions.

16. The adaptive data labeling system of claim 14, wherein the data augmentation component is configured to perform random cropping, scaling and padding, horizontal flipping, lighting, brightness, contrast, hue, augmentations by adding different weather conditions, and combinations thereof.

17. The adaptive data labeling system of claim 14, wherein the tiered hardness component is configured to select instances which are easy and can be automatically labeled, instances of intermediate hardness and that require a mix of human verification and automatic labeling, and instances of hard instances and that require manual labeling.

18. The adaptive data labeling system of claim 14, wherein the consensus based labeling component is configured to use multiple machine learning models and use a consensus mechanism to only label the high confidence data instances.

19. The adaptive data labeling system of claim 14, wherein scenarios of existing pretrained models, and without unlabeled data, can be directly labeled using multiple pre-trained models.

20. The adaptive data labeling system of claim 14, wherein the adaptive data labeling system selects examples given an initial labeled set, a labeling model, and an unlabeled data pool using mechanisms of diversity and uncertainty.
